(19) United States
(12) Patent Application Publication
(10) Pub. No.: US 2007/0228282 A1
(43) Pub. Date: Oct. 4, 2007

(54) Rectangular detector geometry for positron emission tomography

(76) Inventors: Frezghi Habte, Oak Ridge, TN (US); Angela M. Foudray, San Jose, CA (US); Craig S. Levin, Palo Alto, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/726,721

(22) Filed: Mar. 21, 2007

Related U.S. Application Data
(60) Provisional application No. 60/784,233, filed on Mar. 21, 2006.

(51) Int. Cl. G01T 1/164

(52) U.S. Cl. 250/363.03

(57) ABSTRACT

In a PET system having a box-like configuration where four detector panels enclose a field of view, improved photon efficiency is provided by arranging the panels such that a side face of each panel makes contact with a front face of another panel. This arrangement allows for photon efficiency to be improved by “filling in the corners” of the system and/or by adjusting panel positions to conform the field of view to the imaging target along two dimensions. Such adjustment of the field of view does not require altering the size of the detector panels. Furthermore, photon efficiency in embodiments of the invention can be considerably better than the photon efficiency of conventional cylindrical PET arrangements (e.g., as on FIG. 1). Elimination of the wedge-shaped inter-module gaps of the cylindrical geometry can significantly increase efficiency, because Compton scattering into these gaps can be a significant loss mechanism.

### CROSS REFERENCE TO RELATED APPLICATIONS

This application claims the benefit of U.S. provisional patent application 60/784,233, filed on Mar. 21, 2006, entitled “Rectangular Detector Geometry for Positron Emission Tomography”, and hereby incorporated by reference in its entirety.

### GOVERNMENT SPONSORSHIP

This invention was made with Government support under grant number R21 EB003283 from the National Cancer Institute of the National Institutes of Health. The Government has certain rights in this invention.

### FIELD OF THE INVENTION

This invention relates to the arrangement of detectors for positron emission tomography.

### BACKGROUND

Positron emission tomography (PET) is an imaging method based on detection of radiation emitted from electron-positron annihilation events within the imaging target. Such radiation is typically emitted as a pair of 511 keV photons traveling in substantially opposite directions. Accordingly, PET systems are preferably sensitive to time-coincident detection events on opposite sides of the target. In view of the need to detect such spatially separated events, PET systems typically surround the imaging target.

The most common PET system configuration is a cylindrical arrangement, as shown on FIG. 1. Here a PET system 100 includes several detector modules, one of which is labeled as 102, that are arranged to surround a field of view 104. The imaging target (not shown) is disposed in the field of view. Such a system is considered in U.S. Pat. No. 6,242,743. Another conventional approach, considered in U.S. Pat. No. 5,998,792, is to employ a detector configuration that does not surround the field of view, but does provide coincidence detection of oppositely directed photons. The detector assembly is rotated about the field of view during imaging, thereby filling in the image. A less commonly employed known PET system arrangement is the “box” arrangement of FIG. 2, where system 200 includes detector modules 210, 220, 230, and 240 arranged to surround a field of view 250. FIG. 3 shows a top view of the arrangement of FIG. 2.

Box arrangements for PET systems have been proposed for breast imaging by Qi et al. in an article “Comparison of rectangular and dual-planar positron emission mammography scanners” (IEEE Trans. Nucl. Sci. 49(5), pp. 2089-2096, October 2002), and for small animal imaging by Huber et al. in an article “Conceptual design of a high-sensitivity small animal PET camera with 4π coverage” (IEEE Trans. Nucl. Sci. 46(3), pp. 498-502, June 1999). A PET system having rectangularly disposed detector modules having an adjustable distance to the field of view center is considered in U.S. Pat. No. 6,583,420.

As indicated above, a PET system must be able to detect photons emitted by positron annihilation events. Accordingly, the efficiency with which such events are detected by a PET system is a fundamental performance parameter of the PET system. Since it is highly desirable to increase PET system sensitivity, it would be an advance in the art to provide PET systems having improved photon sensitivity.

### SUMMARY

In a PET system having a box-like configuration where four detector panels enclose a field of view, improved photon efficiency is provided by arranging the panels such that a side face of each panel makes contact with a front face of another panel. This arrangement allows for photon efficiency to be improved by “filling in the corners” of the system and/or by adjusting panel positions to conform the field of view to the imaging target along two dimensions. Such adjustment of the field of view does not require altering the size of the detector panels. Furthermore, photon efficiency in embodiments of the invention can be considerably better than the photon efficiency of conventional cylindrical PET arrangements (e.g., as on FIG. 1). Elimination of the wedge-shaped inter-module gaps of the cylindrical geometry can significantly increase efficiency, because photon Compton scattering into these gaps can be a significant photon loss mechanism.

### BRIEF DESCRIPTION OF THE DRAWINGS

FIG. 1 shows a conventional cylindrical PET system.

FIG. 2 shows an isometric view of a known “box” PET system.

FIG. 3 shows a top view of the PET system of FIG. 2.

FIG. 4 shows a top view of a PET system according to an embodiment of the invention.

FIG. 5 shows an isometric view of the example of FIG. 4.

FIG. 6 shows a top view of a PET system according to another embodiment of the invention.

FIG. 7 shows a top view of a PET system according to a further embodiment of the invention.

### DETAILED DESCRIPTION

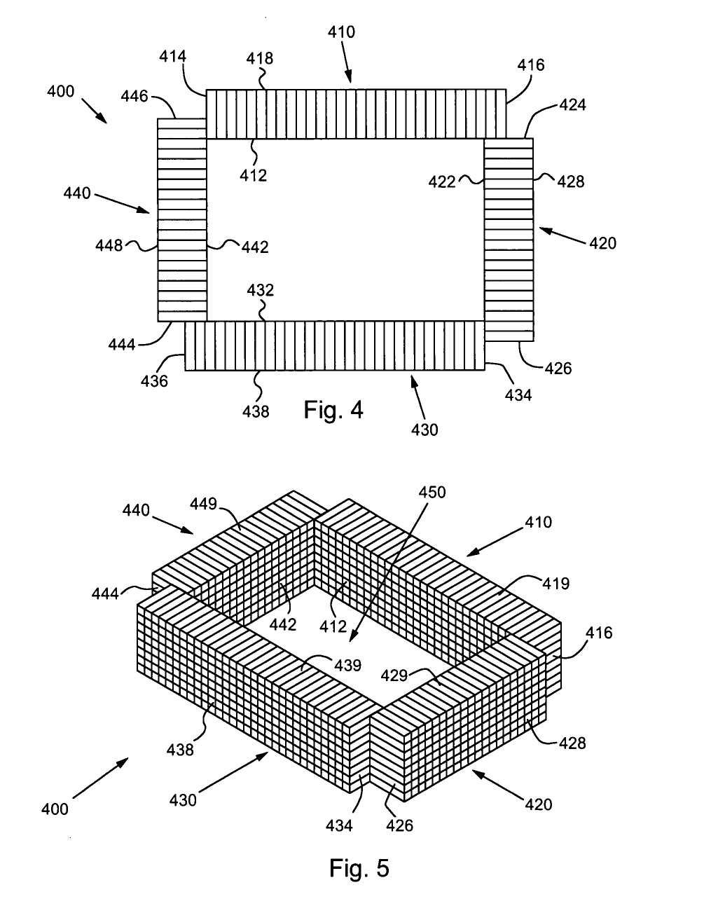

FIGS. 4 and 5 show top and isometric views, respectively, of a PET detector arrangement according to an embodiment of the invention. In this example, a PET system 400 includes four detector array panels, labeled as 410, 420, 430, and 440 enclosing a field of view 450. Each detector array panel preferably has substantially the shape of a parallelepiped. It is convenient to define the “front” faces of each detector panel as the surfaces facing the field of view (i.e., surfaces 412, 422, 432, and 442 of panels 410, 420, 430, and 440, respectively). The “back” surfaces of each detector panel are defined to be the surfaces facing away from the field of view (i.e., surfaces 418, 428, 438, and 448 of panels 410, 420, 430, and 440, respectively).

It is also convenient to take the plane of FIG. 4 to be a reference plane, so the field of view can be regarded as enclosed on four side perpendicular to the reference plane. Each panel has two side surfaces perpendicular to the reference plane. Panel 410 has side surfaces 414 and 416. Panel 420 has side surfaces 424 and 426. Panel 430 has side surfaces 434 and 436. Panel 440 has side surfaces 444 and 446. Each panel also has top surfaces and bottom surfaces parallel to the reference plane. The top surfaces for panels 410, 420, 430, and 440 are shown as 419, 429, 439, and 449 respectively. The bottom surfaces opposite to these top surfaces are not shown in the views of FIGS. 4 and 5.

Each detector array panel provides spatially resolved photon detection. Typically, such spatial resolution is provided by including a two-dimensional array of detector elements in each detector array panel. Detector elements can be based on scintillation, where a scintillation material emits light in response to ionizing radiation, and a photodetector responds to the emitted light from the scintillation material. For example, lutetium oxyorthosilicate scintillation (LSO) crystals can be coupled to position sensitive avalanche photodiodes. Detector elements can also be based on direct detection, where a detector material provides a direct electrical response to ionizing radiation. For example, cadmium zinc telluride (CZT) can be used for direct detection.

Both direct detection and scintillation based detection are well known in the art, and the invention can be practiced with any combination or type of detector elements in the detector array panels. Detector elements providing 3-D coordinate information for detected photons are also known in the art, and such detector elements are preferred in practicing the invention, to reduce parallax error.

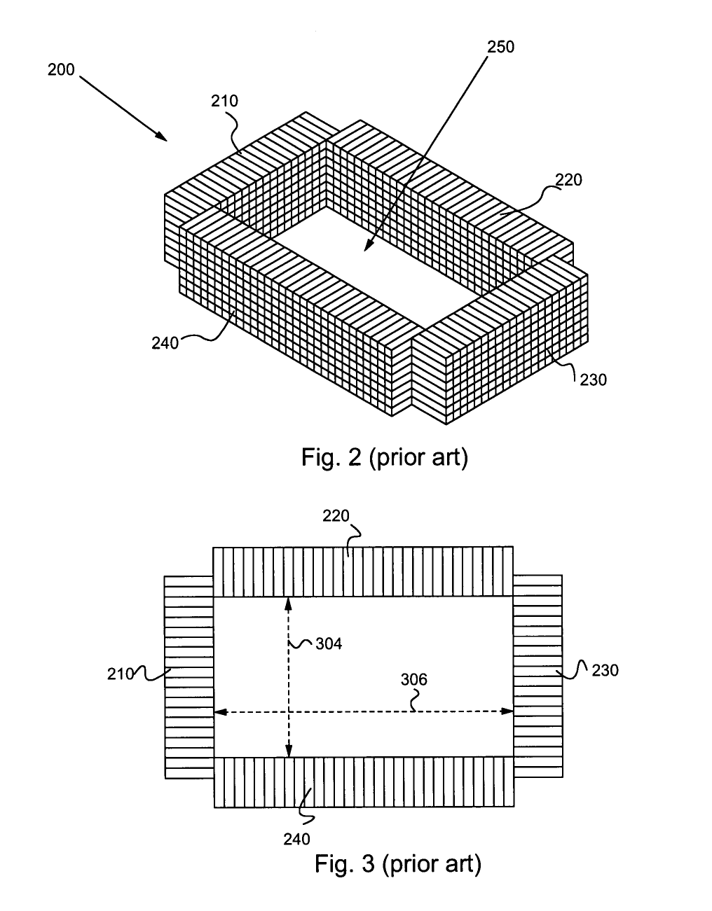

The particular arrangement of detector panels with respect to each other in the example of FIGS. 4 and 5 is significant. More specifically, for each detector array panel, one of its side surfaces makes face to face contact with the front surface of another detector array panel. For example, side surface 414 of panel 410 makes face to face contact with front surface 442 of panel 440. Side surface 424 of panel 420 makes face to face contact with front surface 412 of panel 410. Side surface 434 of panel 430 makes face to face contact with front surface 422 of panel 420. Side surface 444 of panel 440 makes face to face contact with front surface 432 of panel 430. This arrangement of panels differs significantly from the arrangement shown in FIGS. 2 and 3. More specifically, the arrangement of FIGS. 2 and 3 has panels (i.e., panels 210 and 230) whose side surfaces do not make face to face contact with the front surface of any other panel.

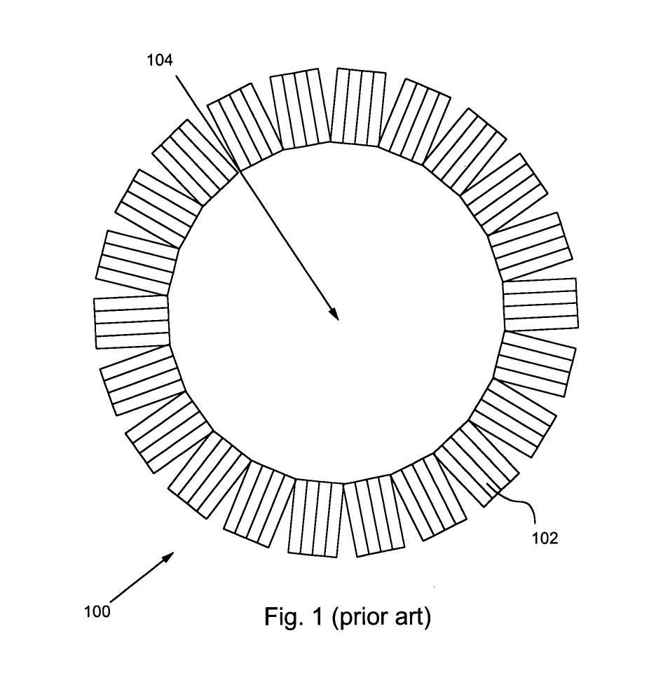

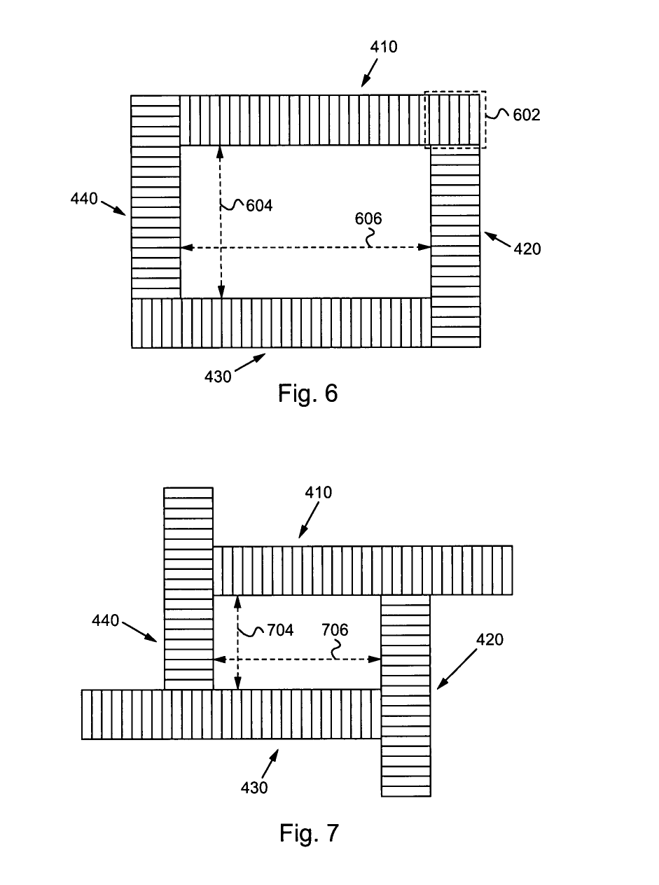

The above “side surface to front surface contact for each panel” arrangement provides significant advantages in practice. In particular, it allows the size of the region enclosed by the detector panels to be varied in two dimensions, without altering the panel size. FIGS. 6 and 7 show examples of how this flexibility can be exploited. In the example of FIG. 6, the field of view dimensions 604 and 606 are selected such that the corner regions (e.g., 602) are completely filled in (as opposed to the partially filled corner regions of FIG. 4). Another way to describe the “filled in corner” condition is that the corner is filled in when the area of the side to front face to face contact is about equal to the area of the relevant side surface. Accordingly, both FIGS. 6 and 7 show “filled in corners”, while FIG. 4 does not. Such complete filling in of the corner regions is advantageous for reducing photon loss, thereby increasing efficiency. The detector array panels preferably have a parallelepiped shape, as indicated above, in order to facilitate filling in the corners without increasing system complexity. Note that the conventional cylindrical system of FIG. 1 could have the wedge-shaped gaps filled in by making the detector modules trapezoidal, but that would significantly increase system complexity.

For example, simulation results show an efficiency increase from 8.5% to 11% for LSO detectors and from 15.5% to 21% for CZT detectors as the panel configuration changes from corner to corner contact to fill in corner regions as on FIG. 6. In these simulations, the detector size was 8 cm axial and 8 cm transaxial, the energy range was 350-650 keV and coincidence-time window settings were 4 ns and 16 ns for LSO and CZT detectors respectively.

FIG. 7 shows an example where the field of view dimensions 704 and 706 are reduced, e.g., to conform the field of view (FOV) dimensions more closely to the dimensions of an imaging target. Such improved correspondence between FOV dimensions and imaging target dimensions can also improve photon sensitivity, by bringing the detector elements as close as possible to the imaging target. For example, in a clinical whole-body PET system simulation, a conventional cylindrical PET system having an 83 cm system diameter and a 55 cm useful transaxial FOV and a 16 cm axial FOV provides a photon sensitivity of about 9 cps/kBq for a line source. Comparable four panel PET systems having transaxial FOVs of 63×63 cm², 53×53 cm² and 41×41 cm² have simulated photon sensitivities for the same line source of 12, 14, and 18 cps/kBq respectively. Although these examples had square transaxial FOVs, a rectangular transaxial FOV can also be employed. Efficiency can be increased by decreasing the FOV dimensions whenever possible, so the size flexibility demonstrated on FIGS. 6 and 7 is of considerable significance in practice. In cases where the FOV is adjusted to conform the FOV dimensions closely to the imaging target dimensions, it is particularly important to employ detector elements providing 3-D detection coordinate information, as indicated above, since uncorrected parallax error has more severe consequences on spatial resolution when the detectors are close to the imaging target.

Note that the arrangement of FIG. 3 does not provide the same degree of FOV size flexibility. In particular, for the example of FIG. 3, FOV dimension 306 cannot be decreased to less than the length of panels 220 and 240, and only FOV dimension 304 can be decreased at will. In contrast, FOV dimensions 604 and 606 on FIG. 6 (and 704 and 706 on FIG. 7) can both be decreased at will be adjusting the positions where panel side surfaces make contact with panel front surfaces. This advantageous ability to adjust both FOV dimensions follows from the panel arrangement described above where each detector panel has a side surface making contact to a front surface of another panel. This arrangement of panels is a common feature of the embodiments of FIGS. 4-7.

The preceding description has been by way of example as opposed to limitation, and the invention can also be practiced according to many variations of the described embodiments. For example, embodiments of the invention are suitable for clinical whole-body imaging, and are also suitable for smaller systems such as small animal imaging and organ specific imaging (e.g., breast imaging).

1. A system for positron emission tomography, the system comprising:
four detector array panels disposed to enclose a field of view on four sides perpendicular to a reference plane, wherein each of the panels has a front surface facing the field of view, and side surfaces perpendicular to the reference plane;
wherein each of the detector array panels provides spatially resolved photon detection;
wherein each one of the panels is disposed such that one of its side surfaces makes face to face contact with the front surface of another one of the panels.

2. The system of claim 1, wherein for each of said panels, an area of said face to face contact is substantially equal to the area of said one of its side surfaces, whereby a photon sensitivity of said system can be increased by eliminating corner gaps of said system.

3. The system of claim 1, wherein a position of said face to face contact on each of said front faces is adjustable, whereby a photon sensitivity of said system can be increased by conforming a size of said field to view to a size of an imaging target within said field of view.

4. The system of claim 1, wherein a size of said field of view is suitable for clinical human whole-body imaging.

5. The system of claim 1, wherein a size of said field of view is suitable for organ specific imaging or small animal imaging.

6. The system of claim 1, wherein said detector array panels comprise detectors selected from the group consisting of: scintillation detectors coupled to position sensitive optical detectors, and detectors providing direct position sensitive detection of ionizing radiation.

7. The system of claim 1, wherein said detector array panels comprise detector elements providing 3-D coordinate information for detected photons, whereby parallax error in imaging can be reduced.

8. The system of claim 1, wherein each of said detector array panels has substantially the shape of a parallelepiped.

9. A method for positron emission tomography, the method comprising:
disposing four detector array panels to enclose a field of view of four side perpendicular to a reference plane, each of the panels having substantially the shape of a parallelepiped, and each of the panels having a front surface facing the field of view, a rear surface facing away from the field of view, top and bottom surfaces parallel to the reference plane, and side surfaces perpendicular to the reference plane;
wherein each of the detector array panels provides spatially resolved photon detection;
wherein each one of the panels is disposed such that one of its side surfaces makes face to face contact with the front surface of another one of the panels;
detecting radiation from an imaging target disposed in the field of view with the detector array panels.

10. The method of claim 9, wherein for each of said panels, an area of said face to face contact is substantially equal to the area of said one of its side surfaces.

11. The method of claim 9, wherein a position of said face to face contact on each of said front faces is adjustable.

12. The method of claim 9, wherein a size of said field of view is suitable for clinical human whole-body imaging.

13. The method of claim 9, wherein a size of said field of view is suitable for organ specific imaging or small animal imaging.

14. The method of claim 9, wherein said detector array panels comprise detectors selected from the group consisting of: scintillation detectors coupled to position sensitive optical detectors, and detectors providing direct position sensitive detection of ionizing radiation.

15. The method of claim 9, wherein said detector array panels comprise detector elements providing 3-D coordinate information for detected photons, whereby parallax error in imaging can be reduced.

16. The method of claim 9, wherein each of said detector array panels has substantially the shape of a parallelepiped.
